(19) United States
(12) Patent Application Publication
(10) Pub. No.: US 2012/0263508 A1
(43) Pub. Date: Oct. 18, 2012

(54) BELT CLEANING APPARATUS AND SYSTEMS FOR BELT FUSER

(75) Inventors: William A. Burton, Fairport, NY (US); Paul M. Fromm, Rochester, NY (US); Augusto E. Barton, Webster, NY (US)

(73) Assignee: XEROX CORPORATION, Norwalk, CT (US)

(21) Appl. No.: 13/088,715

(22) Filed: Apr. 18, 2011

(51) Int. Cl. G03G 15/20

(52) U.S. Cl. 399/327

(57) ABSTRACT

A belt fuser system has a cleaning member with a changeable wick. The cleaning member has a first belt cleaning surface and a second belt cleaning surface. The cleaning member rotates about a longitudinal axis for bringing the first belt cleaning surface and the second belt cleaning surface in contact with a back of a fuser belt.

### FIELD OF DISCLOSURE

The disclosure relates to apparatus and systems for cleaning a fuser belt. Specifically, the disclosure relates to apparatus and systems including a cleaning member having at least a first cleaning surface and a second cleaning surface for cleaning an inner portion of a fuser belt.

### BACKGROUND

Related art belt fuser modules of fuser systems may include a cleaning member such as a cleaning pad and/or wick for cleaning an inner side of a fuser belt. The inner side of the fuser belt touches internal rolls and a stripping shoe. Specifically, the cleaning member may be a wick assembly having a pad that is stationary and positioned to contact a back of the fuser belt during operation of the belt fuser system.

### SUMMARY

Belt cleaning wicks may require frequent replacement due to wear. Belt fusers are typically time-consuming to disassemble and service; replacement of such wicks may require over an hour of service. Belt cleaning members may be one of several belt fuser components that require frequent replacement, sometimes at varying intervals. Consequently, some customers choose to replace an entire belt fuser module when any one of such parts, including the belt cleaning pad and/or wick, requires servicing or replacement.

It is desirable to extend the useful life of belt fuser components to reduce service intervals and improve efficiency. Belt fuser cleaning member apparatus and belt fuser systems in accordance with embodiments include a belt cleaning member that accommodates a changeable belt cleaning surface.

For example, a fuser belt cleaning member in accordance with an exemplary embodiment may include cleaning member having a first cleaning surface and a second cleaning surface. The cleaning member may be a cylindrical structure having a surface comprising, e.g., a wick layer for contacting a fuser belt in a belt fuser system. A first portion of the cleaning member may form a first cleaning surface and a second portion of the cleaning member may form a second cleaning surface.

The cleaning member may be rotatable about a longitudinal axis. The cleaning member may be rotated to at least a first position and a second position. A sprocket may be configured at an end of the shaft for controlling rotation of the shaft. The sprocket may be ratcheted for controlled rotation to one or more cleaning positions.

A belt fuser system having a changeable cleaning member belt contact surface in accordance with another exemplary embodiment may include a cleaning member having a first belt contact surface and a second belt contact surface. The cleaning member may be rotatable about a longitudinal axis of the member. The cleaning member may be rotated to a first position whereby the first contact surface may contact a fuser belt of the belt fuser system. The cleaning member may also be rotated to a second position whereby the second contact surface may contact the fuser belt.

A cleaning member in accordance with an embodiment may comprise a cylindrical cleaning member, the cylindrical cleaning member being being rotatable about a longitudinal axis. The cleaning member may be connected to a belt fuser system that transmits rotary motion to the cleaning member for rotation of the cleaning member. In alternative embodiments, a surface(s) of the cleaning member may be faceted. One face or portion of the cleaning member may include a first belt contact surface, and a second portion of the cleaning member, the second portion being located on a different facet than the first portion, may include a second belt contact surface. The belt cleaning surface may comprise a wick or other suitable belt cleaning structure.

Exemplary embodiments are described herein. It is envisioned, however, that any system that incorporates features of apparatus and systems described herein are encompassed by the scope and spirit of the exemplary embodiments.

### BRIEF DESCRIPTION OF THE DRAWINGS

FIG. 1 shows a partial diagrammatical assembly view of a belt fuser module of a belt fuser system;

FIG. 2 shows a diagrammatical perspective view of a belt cleaning member in accordance with an exemplary embodiment.

### DETAILED DESCRIPTION

Exemplary embodiments are intended to cover all alternatives, modifications, and equivalents as may be included within the spirit and scope of the apparatus, systems, and methods as described herein.

Reference is made to the drawings to accommodate understanding of fuser belt cleaning apparatus and belt fuser systems including belt cleaning members having a more than one cleaning surface. In the drawings, like reference numerals are used throughout to designate similar or identical elements. The drawings depict various embodiments and data related to illustrative belt cleaning apparatus and systems.

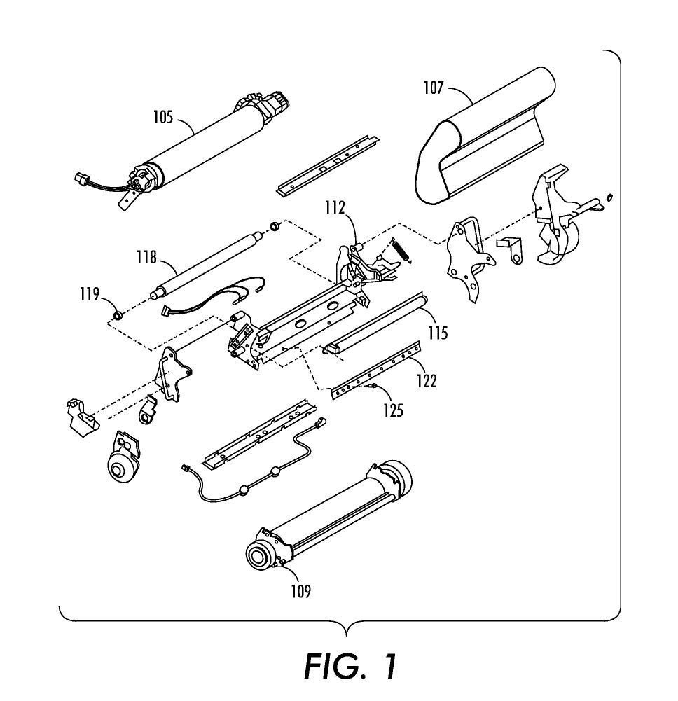

FIG. 1 shows a diagrammatical partial assembly plan view of a belt fuser, and specifically a portion of a belt fuser module. Specifically, FIG. 1 shows an internal heat roll assembly 105, a fuser belt 107, and a heat roll unit 109, which may be operably combined to form a portion of a belt fuser.

The belt fuser may include a frame assembly 112, which may support one or more fuser rolls that entrain the fuser belt 107. The fuser belt 107 may include and inner or back side that contacts the one or more rolls that entrain the fuser belt 107. The fuser belt 107 may comprise a polyimide or other polymer or elastomer material that can rub off on or offset to rolls and other components of the belt fuser.

Belt fuser components such as thermistors, thermostats, and various sensors may be situated about the frame assembly 112. FIG. 1 shows a tension roll assembly 115 attached to the frame assembly 112. FIG. 1 also shows a prenip roll 118 attached to the frame assembly 112 along with bearings 119.

The inner side of the fuser belt 107 may be cleaned to, e.g., enhance fuser component longevity, and prevent contamination of belt fuser components by debris that builds up on the back of the fuser belt. For example, a cleaning member may be configured to clean polyimide and other debris off of an inner side of the fuser belt 107. The cleaning member may be incorporated into the belt fuser for cleaning the belt during operation. FIG. 1 shows a related art belt cleaning member in belt cleaning assembly 122.

Related art belt cleaning assembly 122 is an elongate flat structure that may be secured to the belt-cleaning assembly by, e.g, a screw 125. The related art cleaning assembly 122 is a typical cleaning assembly with a single cleaning surface or pad on which a wick layer is formed. The wick layer may comprise wool, felt or high temperature polyester felt, polymer, for example a polyarimid, or any material suitable for removing and collecting debris from the fuser belt 107 by contact with the cleaning assembly 122. For example, the wick may comprise a meta polyarimid material such as NOMEX®. Further, the wick may comprise oil to enhance debris removal and retention.

Debris such as polyimide may be produced by, e.g., the wear of the inside of the fuser belt and other materials, wear of the low friction coating on the stripping shoe, accumulation of gelled silicone oil, paper dust, and/or wear debris for temp sensors. Such debris may be removed from the belt 107 as the belt translates past, and contacts the cleaning assembly 122. Specifically, a portion of the cleaning assembly positioned near the inner side of the belt 107 during operation may be configured to contact the belt 107.

The cleaning member may be a pad and wick or other suitable structure. The cleaning member in related art systems is stationary, and after becoming contaminated through prolonged use, the cleaning member must be replaced with a new cleaning member having an uncontaminated belt contact surface or cleaning portion. Replacement of the cleaning member is typically time consuming, costly, and frequently required.

An apparatus in accordance with an exemplary embodiment may include a cleaning member having first cleaning surface. The first cleaning surface or belt contact surface may comprise a wick having a NOMEX® felt material, a wool or woven material, or other material now known or later developed that is suitable for cleaning debris from a back of a fuser belt in a belt fuser system. The cleaning member may include a second belt contact surface for cleaning the back of the fuser belt. The cleaning member is configured to be movable to a first position and a second position. At a first position, the first belt contact surface may be arranged to contact and clean the fuser belt. The cleaning member may be moved to a second position wherein the first contact surface is not in contact with the fuser belt, and a second contact surface is arranged to contact the fuser belt.

As such, when the first contact surface is exhausted and requires replacement, e.g., the surface is contaminated with belt debris, the first contact surface may be removed from contact with the belt, and the second contact surface may be arranged to contact the belt. For example, in an embodiment having a fuser belt cleaning member with a first cleaning or contact surface and a second cleaning surface, the cleaning member may include a cylindrical structure having a wick surface for contacting a fuser belt in a belt fuser system. The wick surface may be a layer that covers some, or all, of the shaft.

A first portion of the surface of the cylindrical cleaning member may include a first cleaning surface, and a second portion of the cleaning member may include a second cleaning surface. The cleaning member may be rotatable about a longitudinal axis. The cleaning member may be configured to be rotateable to at least a first position and a second position. A sprocket may be configured at an end of the cleaning member for controlling rotation of the cleaning member. The sprocket may be ratcheted for control and ease of selecting one or more cleaning positions.

In a belt fuser system having a changeable cleaning member belt contact surface in accordance with an exemplary embodiment, a belt fuser system may include a cleaning member with at least a first belt contact surface and a second contact surface. The cleaning member may be configured and arranged in the belt fuser to rotate about a longitudinal axis.

The cleaning member may be configured so that select belt cleaning contact surfaces, when operably positioned, contact a back or inner portion of a fuser belt in the belt fuser. The cleaning member may be rotated to a first position whereby the first contact surface may contact a fuser belt of the belt fuser system. The cleaning member may be rotated to a second position whereby the second contact surface may contact the fuser belt, instead of the first contact surface.

The cleaning member may comprise a cylindrical structure that is rotatable about a longitudinal axis of the shaft. The cleaning member may be connected to a belt fuser system that transmits rotary motion to the shaft for rotation of the cleaning member. The cleaning member may be rotated as necessary to load different contact surface when one surface becomes too contaminated for further use. For example, the first contact surface may be located on a first portion of the cylindrical cleaning member, and the second contact surface may be located on a second portion of the cylindrical cleaning member. In embodiments, the first portion moves away from a belt contact position as the second portion is caused to move to a belt contact position.

In alternative embodiments, a surface(s) of the cleaning member may be faceted. For example, the cleaning member may have a six-side surface, an eight-sided surface, or a 16-sided surface, with each facet being a separate portion. A first belt contact surface may be located on a first portion, i.e., a first face, and a second contact surface may be located on a second portion on a different face of the cleaning member. The cleaning member may be rotatable about a longitudinal axis when arranged in a belt fuser. Specifically, the cleaning member may be rotated to at least a first position and a second position. In the first position, the first contact surface of a first facet may contact an inner portion of a fuser belt of a belt fuser. The cleaning member may be rotated to a second position whereby the first contact surface is moved away from the fuser belt, and the second contact surface is positioned to contact the fuser belt.

Accordingly, when a wick of the first contact surface, for example, is contaminated and requires replacement, the cleaning member may be rotated to replace the first contact surface with a second contact surface having a wick that is not contaminated. More than two contact surfaces may be incorporated into a cleaning member of apparatus and systems in accordance with embodiments.

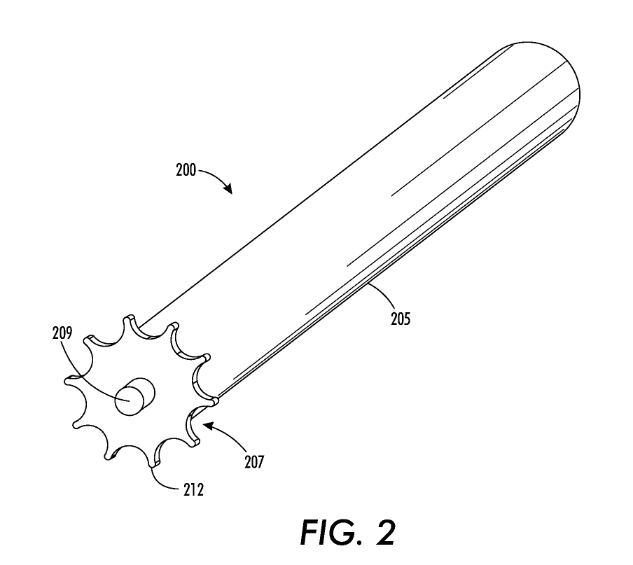

FIG. 2 shows a cleaning member in accordance with an exemplary embodiment. Specifically, FIG. 2 shows a cleaning member 200 having a pin or support shaft 209. A cleaning surface 205 may be an elongate cylindrical structure as shown. In alternative embodiments, the cleaning member may take any form that is suitable for changeably positioning multiple cleaning surfaces of the cleaning member for contact with a fuser belt of a belt fuser.

The cleaning member 200 may include a cleaning surface 205 having a layer comprising a compliant porous material like a non-woven felt. The felt may comprise a woven or non-woven wool material, and/or may comprise polymer material. For example, the cleaning surface 205 may comprise a NOMEX® layer suitable for removing and retaining debris such as polyimide from a back of a fuser belt. The surface of the cleaning member 200 may include a first portion and a second portion. The first portion may be arranged with respect to the second portion such that the shaft is rotatable to bring one of the first portion and the second portion near a fuser belt to facilitate contact of the belt by a first belt contact surface or a second belt contact surface located on the first and second shaft portions, respectively.

The cleaning member 200 may include a first end 207. At the first end 207, a sprocket 212, or alternatively a toothed or facetted wheel, a surface with depressions or protrusion(s) and a corresponding detent device to hold the position of the cleaning member with some predetermined torque, may be fitted to or formed by the cleaning member. The sprocket may be a ratcheting sprocket that accommodates controlled rotation and positioning of the cleaning member. The shaft 209, sprocket 212, and cleaning surface 205 may all be in communication with each so that if one rotates they all rotate. Specifically, a rotational motion may be transmitted form a belt fuser having the depicted cleaning member, to the rotatable shaft 209 by way of the sprocket 212. Alternatively, a simple and quick means of manually moving the cleaning member 200 from one facet to the next could be provided. For example, the cleaning member 200 may be rotated by a hand crank. The cleaning member 200 may be connected to the belt fuser by, e.g., a shaft 209. A belt fuser frame may be configured, for example, to include an access hole(s) that accommodate a rotatable cleaning member that is rotatable or movable to at least two positions. A numbered or colored flag may be associated with the cleaning member position, or may be arranged to indicate a portion or facet of the cleaning member that is nearest to or contacts the fuser belt.

The cleaning surface 205 of the cleaning member 200 may be rotatable to at least a first position and a second position. For example, when arranged in a belt fuser, the cleaning surface 205 may be rotated by way of sprocket 212 to a first position. At the first position, a first portion of the cleaning member 200 may be positioned near a fuser belt. The first portion may include a first belt contact surface, which may include a contact surface may comprise a felt material or wick or other suitable material for cleaning the fuser belt.

The second portion of the cleaning member 200 may include a second belt contact surface, which may comprise a felt material or wick or other suitable structure. When the shaft is in a first position, the cleaning member 200 may be rotated to move the first portion having the first contact surface away from the fuser belt, and move the second portion having the second contact surface near the fuser belt at a second position. Specifically, the cleaning member 200 may be rotated to a second position whereby the second contact surface contacts the fuser belt. In alternative embodiments, the shaft may include third, fourth, and further belt cleaning contact surfaces.

While fuser belt cleaning apparatus and systems are described in relationship to exemplary embodiments, many alternatives, modifications, and variations would be apparent to those skilled in the art. Accordingly, embodiments of apparatus and systems as set forth herein are intended to be illustrative, not limiting. There are changes that may be made without departing from the spirit and scope of the exemplary embodiments.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. A fuser belt cleaning apparatus, comprising:
a cleaning member having a first belt contact surface and a second belt contact surface.

2. The fuser belt cleaning apparatus of claim 1, the cleaning member further comprising:
a cleaning member shaft, the cleaning member being rotatable about a longitudinal axis of the shaft.

3. The fuser belt cleaning apparatus of claim 2, the cleaning member further comprising:
a sprocket attached to an end of the cleaning member, the sprocket being configured to control rotation of the cleaning member to a first position and a second position.

4. The fuser belt cleaning apparatus of claim 3, wherein the first belt contact surface contacts a fuser belt in the first position, and the second belt contact surface contacts the fuser belt in the second position.

5. The fuser belt cleaning apparatus of 2, the cleaning member further comprising the cleaning member shaft being rotatable about the longitudinal axis to at least a first position and a second position.

6. The fuser belt cleaning apparatus of claim 5, wherein the first belt contact surface contacts the fuser belt in the first position and the second belt contact surface contacts the fuser belt in the second position.

7. The fuser belt cleaning apparatus of claim 5, the cleaning member further comprising:
a sprocket configured to lock the rotatable cleaning member in one of the first position and the second position.

8. A belt fuser system having a changeable cleaning member belt contact surface, the system comprising:
a cleaning member having a first belt contact surface and a second belt contact surface, the cleaning member being rotatable about a longitudinal axis, the cleaning member having a first end, the first end being in communication with a belt fuser.

9. The system of claim 8, further comprising the belt fuser being configured to rotate the cleaning member.

10. The system of claim 8, further comprising:
a fuser belt, the fuser belt having a front substrate contact side and a back entraining member contact side.

11. The system of claim 10, wherein the first belt contact surface and second belt contact surface contact the back of the fuser belt when the cleaning member is rotated to one of the first position and the second position, respectively.

12. The system of claim 8, further comprising the cleaning member being cylindrical and configured to rotate to a first position whereby the first belt contact surface contacts a back of a fuser belt; and a second position whereby the second belt contact portion contacts a back of the fuser.

13. The system of claim 12, further comprising the first contact surface being positioned away the fuser belt when the second belt contact surface contacts the fuser belt.

14. The system of claim 8, the cleaning member being a faceted cleaning member having a first belt contact surface and a second belt contact surface, the cleaning member being rotatable about the longitudinal axis to bring one of the first belt contact surface and the second belt contact surface in contact with the fuser belt.

15. The system of claim 8, the end of the cleaning member further comprising:
a sprocket, the sprocket being configured to rotate the cleaning member to one of the first position and the second position.

16. The system of claim 8, the end of the cleaning member further comprising:
a sprocket being configured to transmit rotary motion from one of the belt fuser system and manual hand crank to the rotatable cleaning member.

17. A fuser belt cleaning member, comprising:
an elongate body having at least a first portion and a second portion;
a first belt cleaning surface located on the first portion the body;
a second belt cleaning surface located on the second portion of the body.

18. The fuser belt cleaning member of claim 17, further comprising:
a ratcheting sprocket for controlling rotation of the elongate body, the body being rotatable about a longitudinal axis, the ratcheting sprocket being configured to control rotation of the body to a first position and a second position.

19. The fuser belt backside cleaning member of claim 17, further comprising the body being cylindrical, the first portion and the second portion being located on a surface of the cylindrical body.

20. The fuser belt-back side cleaning member of claim 17, further comprising the body being faceted whereby the surface of the cylindrical body defines at least one of six, eight, and sixteen faces.
